(19) United States
(12) Patent Application Publication
(10) Pub. No.: US 2016/0187206 A1
(43) Pub. Date: Jun. 30, 2016

(54) CALIBRATION APPARATUS FOR WIRELESS TEMPERATURE RECORDER AND CALIBRATION SYSTEM FOR WIRELESS TEMPERATURE RECORDER

(71) Applicant: Jogtek Corp., Taipei City (TW)

(72) Inventor: Tsung-Hsing HSIEH, Taipei City (TW)

(21) Appl. No.: 14/582,926

(22) Filed: Dec. 24, 2014

(51) Int. Cl. G01K 15/00; G01K 1/02

(52) U.S. Cl. CPC G01K 15/005; G01K 1/022

(57) ABSTRACT

A calibration apparatus includes an upper cover body, a lower cover body, a thermometer, a controller, a radio frequency identification reader-writer, a heating unit and a cooling unit. An accommodation space is defined to include an inner side space of the upper cover body and an inner side space of the lower cover body. A wireless temperature recorder is arranged inside the accommodation space. The controller is configured to control the heating unit and the cooling unit, so that a temperature of the accommodation space measured by the thermometer reaches a stable first temperature. The controller is configured to control the radio frequency identification reader-writer to wirelessly command the wireless temperature recorder to measure the temperature of the accommodation space and record the temperature of the accommodation space as a first data.

### BACKGROUND OF THE INVENTION

1. Field of the Invention

The present invention relates to a calibration apparatus and a calibration system, and especially relates to a calibration apparatus for a wireless temperature recorder and a calibration system for a wireless temperature recorder.

2. Description of the Related Art

A wireless temperature recorder is used widely for measuring and recording temperature. When the wireless temperature recorder is manufactured, the wireless temperature recorder has to be calibrated, so that the wireless temperature recorder can measure temperature correctly. Usually, the wireless temperature recorder is calibrated with a calibration apparatus. Different calibration apparatuses have different temperatures in inner side spaces. The wireless temperature recorder is arranged in different calibration apparatuses to calibrate temperature measuring.

However, the disadvantage of the current calibration apparatus is that calibrating the wireless temperature recorder is too slow.

### SUMMARY OF THE INVENTION

In order to solve the above-mentioned problems, an object of the present invention is to provide a calibration apparatus.

In order to solve the above-mentioned problems, another object of the present invention is to provide a calibration system.

In order to achieve the object of the present invention mentioned above, the calibration apparatus is applied to a wireless temperature recorder. The calibration apparatus comprises an upper cover body, a bearing, a lower cover body, a temperature probe, a thermometer, a controller, a radio frequency identification reader-writer, a radio frequency identification antenna, a heating unit and a cooling unit. The bearing is arranged at one side of the upper cover body and one side of the lower cover body, so that the upper cover body is opened or closed with respect to the lower cover body. An accommodation space is defined to include an inner side space of the upper cover body and an inner side space of the lower cover body. The wireless temperature recorder is arranged inside the accommodation space. One side of the temperature probe touches the wireless temperature recorder through the lower cover body. The thermometer is electrically connected to the other side of the temperature probe. The controller is electrically connected to the thermometer. The radio frequency identification reader-writer is electrically connected to the controller. The radio frequency identification antenna is arranged inside the accommodation space and is electrically connected to the radio frequency identification reader-writer through the upper cover body. The radio frequency identification antenna is wirelessly electrically connected to the wireless temperature recorder. The heating unit is electrically connected to the controller. The heating unit is connected to the upper cover body and heats the accommodation space. The cooling unit is electrically connected to the controller. The cooling unit is connected to the lower cover body and cools the accommodation space.

Moreover, the calibration apparatus further comprises a first fan, a second fan, a first heat sink and a second heat sink. The first fan is electrically connected to the controller and arranged on the upper cover body. The second fan is electrically connected to the controller and arranged on the lower cover body. The first heat sink is connected to the heating unit. The second heat sink is connected to the cooling unit.

Moreover, the calibration apparatus further comprises a first metal layer and a second metal layer. The first metal layer is connected to an inner side of the upper cover body. The second metal layer is connected to an inner side of the lower cover body.

Moreover, the calibration apparatus further comprises a first high permeability ferrite absorbing material and a second high permeability ferrite absorbing material. The first high permeability ferrite absorbing material is connected to the first metal layer. The second high permeability ferrite absorbing material is connected to the second metal layer.

Moreover, an inside of the upper cover body is vacuum or filled with a styrofoam for thermal insulation. An inside of the lower cover body is vacuum or filled with a styrofoam for thermal insulation. The thermometer is a high precision thermometer.

In order to achieve another object of the present invention mentioned above, the calibration system comprises a wireless temperature recorder and a calibration apparatus. The calibration apparatus comprises an upper cover body, a bearing, a lower cover body, a temperature probe, a thermometer, a controller, a radio frequency identification reader-writer, a radio frequency identification antenna, a heating unit and a cooling unit. The bearing is arranged at one side of the upper cover body and one side of the lower cover body, so that the upper cover body is opened or closed with respect to the lower cover body. An accommodation space is defined to include an inner side space of the upper cover body and an inner side space of the lower cover body. The wireless temperature recorder is arranged inside the accommodation space. One side of the temperature probe touches the wireless temperature recorder through the lower cover body. The thermometer is electrically connected to the other side of the temperature probe. The controller is electrically connected to the thermometer. The radio frequency identification reader-writer is electrically connected to the controller. The radio frequency identification antenna is arranged inside the accommodation space and is electrically connected to the radio frequency identification reader-writer through the upper cover body. The radio frequency identification antenna is wirelessly electrically connected to the wireless temperature recorder. The heating unit is electrically connected to the controller. The heating unit is connected to the upper cover body and heats the accommodation space. The cooling unit is electrically connected to the controller. The cooling unit is connected to the lower cover body and cools the accommodation space.

Moreover, the calibration apparatus further comprises a first fan, a second fan, a first heat sink and a second heat sink. The first fan is electrically connected to the controller and arranged on the upper cover body. The second fan is electrically connected to the controller and arranged on the lower cover body. The first heat sink is connected to the heating unit. The second heat sink is connected to the cooling unit.

Moreover, the calibration apparatus further comprises a first metal layer and a second metal layer. The first metal layer is connected to an inner side of the upper cover body. The second metal layer is connected to an inner side of the lower cover body.

Moreover, the calibration apparatus further comprises a first high permeability ferrite absorbing material and a second high permeability ferrite absorbing material. The first high permeability ferrite absorbing material is connected to the first metal layer. The second high permeability ferrite absorbing material is connected to the second metal layer.

Moreover, an inside of the upper cover body is vacuum or filled with a styrofoam for thermal insulation. An inside of the lower cover body is vacuum or filled with a styrofoam for thermal insulation. The thermometer is a high precision thermometer.

The advantage of the present invention is to calibrate the wireless temperature recorder quickly and continuously.

### BRIEF DESCRIPTION OF DRAWING

FIG. 1 shows a block diagram of the calibration apparatus of the present invention.

FIG. 2 shows a block diagram of the calibration system of the present invention.

FIG. 3 shows a block diagram of the wireless temperature recorder of the present invention.

### DETAILED DESCRIPTION OF THE INVENTION

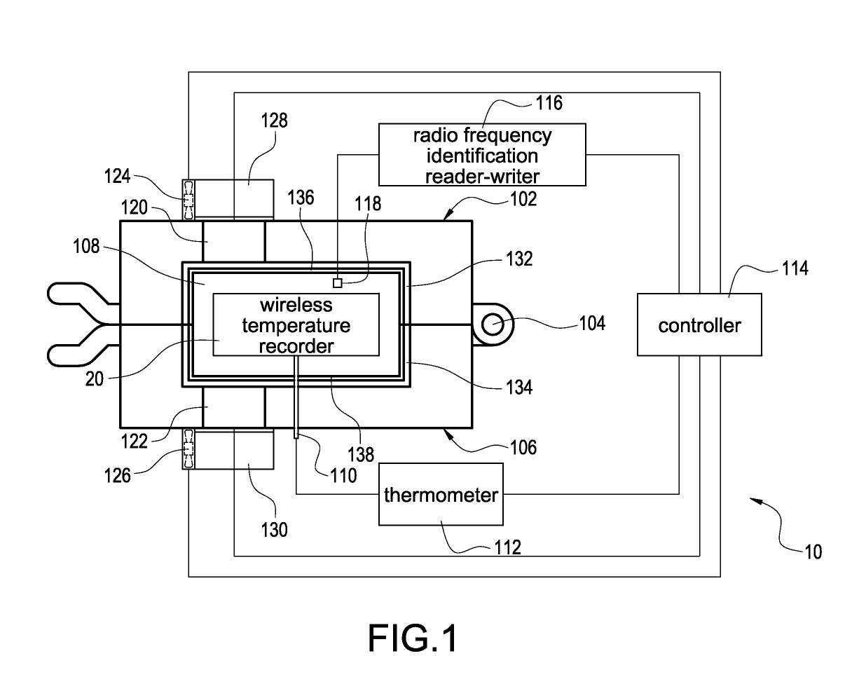

FIG. 1 shows a block diagram of the calibration apparatus of the present invention. A calibration apparatus 10 is applied to a wireless temperature recorder 20. The calibration apparatus 10 comprises an upper cover body 102, a bearing 104, a lower cover body 106, a temperature probe 110, a thermometer 112, a controller 114, a radio frequency identification reader-writer 116, a radio frequency identification antenna 118, a heating unit 120, a cooling unit 122, a first fan 124, a second fan 126, a first heat sink 128, a second heat sink 130, a first metal layer 132, a second metal layer 134, a first high permeability ferrite absorbing material 136 and a second high permeability ferrite absorbing material 138.

The bearing 104 is arranged at one side of the upper cover body 102 and one side of the lower cover body 106, so that the upper cover body 102 is opened or closed with respect to the lower cover body 106. An accommodation space 108 is defined to include an inner side space of the upper cover body 102 and an inner side space of the lower cover body 106. The wireless temperature recorder 20 is arranged inside the accommodation space 108.

One side of the temperature probe 110 touches the wireless temperature recorder 20 through the lower cover body 106, the second metal layer 134 and the second high permeability ferrite absorbing material 138. The temperature probe 110 is not electrically connected to the lower cover body 106, the second metal layer 134 and the second high permeability ferrite absorbing material 138. The thermometer 112 is electrically connected to the other side of the temperature probe 110. The controller 114 is electrically connected to the thermometer 112. The radio frequency identification reader-writer 116 is electrically connected to the controller 114.

The radio frequency identification antenna 118 is arranged inside the accommodation space 108 and is electrically connected to the radio frequency identification reader-writer 116 through the upper cover body 102, the first metal layer 132 and the first high permeability ferrite absorbing material 136. The radio frequency identification antenna 118 is not electrically connected to the upper cover body 102, the first metal layer 132 and the first high permeability ferrite absorbing material 136. The radio frequency identification antenna 118 is wirelessly electrically connected to the wireless temperature recorder 20. The heating unit 120 is electrically connected to the controller 114. The heating unit 120 is connected to the upper cover body 102 and heats the accommodation space 108. The cooling unit 122 is electrically connected to the controller 114. The cooling unit 122 is connected to the lower cover body 106 and cools the accommodation space 108.

The first fan 124 is electrically connected to the controller 114 and arranged on the upper cover body 102. The second fan 126 is electrically connected to the controller 114 and arranged on the lower cover body 106. The first heat sink 128 is connected to the heating unit 120. The second heat sink 130 is connected to the cooling unit 122.

The first metal layer 132 is connected to an inner side of the upper cover body 102. The second metal layer 134 is connected to an inner side of the lower cover body 106. The first high permeability ferrite absorbing material 136 is connected to the first metal layer 132. The second high permeability ferrite absorbing material 138 is connected to the second metal layer 134. An inside of the upper cover body 102 is vacuum or filled with a styrofoam for thermal insulation. An inside of the lower cover body 106 is vacuum or filled with a styrofoam for thermal insulation. The thermometer 112 is a high precision thermometer. The thermal conductivity of the first metal layer 132 is good. The thermal conductivity of the second metal layer 134 is good.

The radio frequency identification (RFID) mentioned above can be replaced by the near field communication (NFC). The controller 114 is configured to control the heating unit 120, the cooling unit 122, the first fan 124 and the second fan 126 through a general purpose input/output (GPIO, not shown in FIG. 1). The controller 114 is configured to control the thermometer 112 through a universal serial bus (USB) or an RS232. The wireless temperature recorder 20 is a radio frequency identification tag or a near field communication tag, and will be described afterward.

The controller 114 is configured to control the heating unit 120, the cooling unit 122, the first fan 124 and the second fan 126, so that a temperature of the accommodation space 108 measured by the thermometer 112 through the temperature probe 110 reaches a stable first temperature (for example 25 degrees Celsius). The controller 114 is aware of the temperature of the accommodation space 108 according to the thermometer 112. The controller 114 is configured to control the radio frequency identification reader-writer 116 to wirelessly command the wireless temperature recorder 20 through the radio frequency identification antenna 118 to measure the temperature of the accommodation space 108 and record the temperature of the accommodation space 108 as a first data.

The controller 114 is configured to control the heating unit 120, the cooling unit 122, the first fan 124 and the second fan 126, so that the temperature of the accommodation space 108 measured by the thermometer 112 through the temperature probe 110 reaches a stable second temperature (for example 10 degrees Celsius). The controller 114 is aware of the temperature of the accommodation space 108 according to the thermometer 112. The controller 114 is configured to control the radio frequency identification reader-writer 116 to wirelessly command the wireless temperature recorder 20 through the radio frequency identification antenna 118 to measure the temperature of the accommodation space 108 and record the temperature of the accommodation space 108 as a second data.

The controller 114 is configured to control the heating unit 120, the cooling unit 122, the first fan 124 and the second fan 126, so that the temperature of the accommodation space 108 measured by the thermometer 112 through the temperature probe 110 reaches a stable third temperature (for example 0 degrees Celsius). The controller 114 is aware of the temperature of the accommodation space 108 according to the thermometer 112. The controller 114 is configured to control the radio frequency identification reader-writer 116 to wirelessly command the wireless temperature recorder 20 through the radio frequency identification antenna 118 to measure the temperature of the accommodation space 108 and record the temperature of the accommodation space 108 as a third data.

The wireless temperature recorder 20 is removed from the accommodation space 108. The wireless temperature recorder 20 is calibrated by a calibration equipment (not shown in FIG. 1, such as a computer) or the controller 114 (so that the wireless temperature recorder 20 will be connected to the controller 114 after the wireless temperature recorder 20 is removed from the accommodation space 108) according to the first data, the second data and the third data. Namely, the calibration equipment or the controller 114 compares the first data, the second data and the third data with a standard data which is in accordance with the stable first temperature, the stable second temperature and the stable third temperature to obtain a deviation. The wireless temperature recorder 20 records the deviation. After that, the wireless temperature recorder 20 will measure temperature and then add the deviation to the temperature to obtain correct temperature.

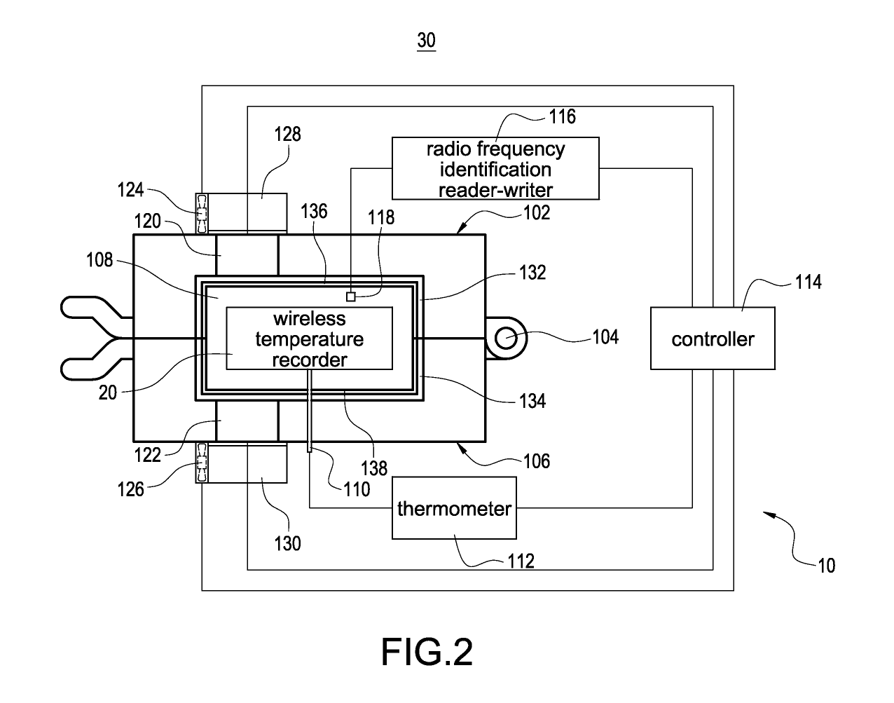

FIG. 2 shows a block diagram of the calibration system of the present invention. A calibration system 30 comprises a wireless temperature recorder 20 and a calibration apparatus 10. The description for the elements shown in FIG. 2, which are similar to those shown in FIG. 1, is not repeated here for brevity.

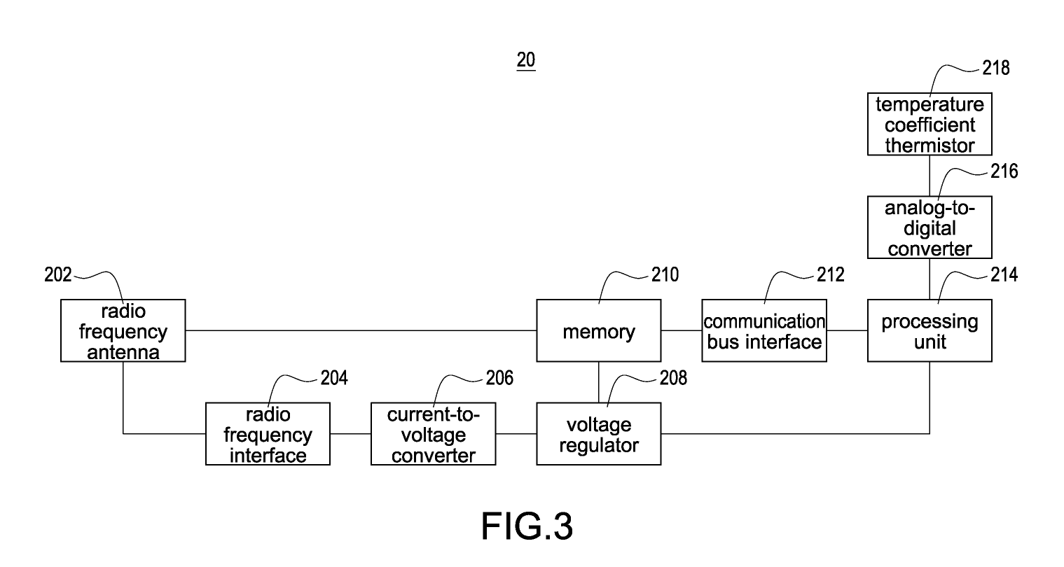

FIG. 3 shows a block diagram of the wireless temperature recorder of the present invention. The wireless temperature recorder 20 shown in FIG. 3 is applicable in FIG. 1 and FIG. 2. The wireless temperature recorder 20 comprises a radio frequency antenna 202, a radio frequency interface 204, a current-to-voltage converter 206, a voltage regulator 208, a memory 210, a communication bus interface 212, a processing unit 214, an analog-to-digital converter 216 and a temperature coefficient thermistor 218.

The radio frequency interface 204 is electrically connected to the radio frequency antenna 202. The current-to-voltage converter 206 is electrically connected to the radio frequency interface 204. The voltage regulator 208 is electrically connected to the current-to-voltage converter 206. The memory 210 is electrically connected to the current-to-voltage converter 206 and the radio frequency antenna 202. The communication bus interface 212 is electrically connected to the memory 210. The processing unit 214 is electrically connected to the communication bus interface 212 and the voltage regulator 208. The analog-to-digital converter 216 is electrically connected to the processing unit 214. The temperature coefficient thermistor 218 is electrically connected to the analog-to-digital converter 216. The temperature coefficient thermistor 218 is a negative temperature coefficient thermistor or a positive temperature coefficient thermistor. The analog-to-digital converter 216 and the temperature coefficient thermistor 218 can be replaced by a temperature sensor.

The advantage of the present invention is to calibrate the wireless temperature recorder quickly and continuously.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A calibration apparatus applied to a wireless temperature recorder, the calibration apparatus comprising:
an upper cover body;
a bearing;
a lower cover body, the bearing arranged at one side of the upper cover body and one side of the lower cover body, so that the upper cover body is opened or closed with respect to the lower cover body; an accommodation space defined to include an inner side space of the upper cover body and an inner side space of the lower cover body, the wireless temperature recorder arranged inside the accommodation space;
a temperature probe, one side of the temperature probe touching the wireless temperature recorder through the lower cover body;
a thermometer electrically connected to the other side of the temperature probe;
a controller electrically connected to the thermometer;
a radio frequency identification reader-writer electrically connected to the controller;
a radio frequency identification antenna arranged inside the accommodation space and electrically connected to the radio frequency identification reader-writer through the upper cover body, the radio frequency identification antenna wirelessly electrically connected to the wireless temperature recorder;
a heating unit electrically connected to the controller, the heating unit connected to the upper cover body and heating the accommodation space; and
a cooling unit electrically connected to the controller, the cooling unit connected to the lower cover body and cooling the accommodation space.

2. The calibration apparatus in claim 1 further comprising:
a first fan electrically connected to the controller and arranged on the upper cover body;
a second fan electrically connected to the controller and arranged on the lower cover body;
a first heat sink connected to the heating unit; and
a second heat sink connected to the cooling unit.

3. The calibration apparatus in claim 2 further comprising:
a first metal layer connected to an inner side of the upper cover body; and
a second metal layer connected to an inner side of the lower cover body.

4. The calibration apparatus in claim 3 further comprising:
a first high permeability ferrite absorbing material connected to the first metal layer; and
a second high permeability ferrite absorbing material connected to the second metal layer.

5. The calibration apparatus in claim 4, wherein an inside of the upper cover body is vacuum or filled with a styrofoam for thermal insulation; an inside of the lower cover body is vacuum or filled with a styrofoam for thermal insulation; the thermometer is a high precision thermometer.

6. A calibration system comprising:
a wireless temperature recorder; and
a calibration apparatus,
wherein the calibration apparatus comprises:
an upper cover body;
a bearing;
a lower cover body, the bearing arranged at one side of the upper cover body and one side of the lower cover body, so that the upper cover body is opened or closed with respect to the lower cover body; an accommodation space defined to include an inner side space of the upper cover body and an inner side space of the lower cover body, the wireless temperature recorder arranged inside the accommodation space;
a temperature probe, one side of the temperature probe touching the wireless temperature recorder through the lower cover body;
a thermometer electrically connected to the other side of the temperature probe;
a controller electrically connected to the thermometer;
a radio frequency identification reader-writer electrically connected to the controller;
a radio frequency identification antenna arranged inside the accommodation space and electrically connected to the radio frequency identification reader-writer through the upper cover body, the radio frequency identification antenna wirelessly electrically connected to the wireless temperature recorder;
a heating unit electrically connected to the controller, the heating unit connected to the upper cover body and heating the accommodation space; and
a cooling unit electrically connected to the controller, the cooling unit connected to the lower cover body and cooling the accommodation space.

7. The calibration system in claim 6, wherein the calibration apparatus further comprises:
a first fan electrically connected to the controller and arranged on the upper cover body;
a second fan electrically connected to the controller and arranged on the lower cover body;
a first heat sink connected to the heating unit; and
a second heat sink connected to the cooling unit.

8. The calibration system in claim 7, wherein the calibration apparatus further comprises:
a first metal layer connected to an inner side of the upper cover body; and
a second metal layer connected to an inner side of the lower cover body.

9. The calibration system in claim 8, wherein the calibration apparatus further comprises:
a first high permeability ferrite absorbing material connected to the first metal layer; and
a second high permeability ferrite absorbing material connected to the second metal layer.

10. The calibration system in claim 9, wherein an inside of the upper cover body is vacuum or filled with a styrofoam for thermal insulation; an inside of the lower cover body is vacuum or filled with a styrofoam for thermal insulation; the thermometer is a high precision thermometer.
